(19) United States
(12) Patent Application Publication
(10) Pub. No.: US 2006/0060097 A1
(43) Pub. Date: Mar. 23, 2006

(54) Method and apparatus for producing printing plates

(75) Inventor: Hiroshi Sunagawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/230,740

(22) Filed: Sep. 21, 2005

(30) Foreign Application Priority Data
Sep. 21, 2004 (JP) 2004-273568
Sep. 21, 2004 (JP) 2004-273705
Mar. 8, 2005 (JP) 2005-064175

(51) Int. Cl. B41N 3/00

(52) U.S. Cl. 101/463.1

(57) ABSTRACT

The process and apparatus for producing printing plates enable the production of printing plates without wet development processing. The printing plate is exposed to form an image on the printing plate from an exposed area which has got a spectral absorption change to occur in an invisible range. While at the same time the spectral absorption change in the invisible range is read, the image formed by the thus read spectral absorption change is reconstructing as a visible image, and the thus reconstructed visible image is outputted. Alternatively, the information that needs to be read in a subsequent printing step is drawn by an ink jet in an area of the printing plate where the exposure has ended.

### BACKGROUND OF THE INVENTION

This invention relates to a method and apparatus for producing printing plates. More specifically, the invention relates to a method and apparatus for producing printing plates which are improved not only in the way of checking an image or the like on a printing plate after exposure, particularly on a so-called “non-processing” printing plate which is not supposed to receive wet development processing, but also in the way of forming register marks and printing plate identifying information (including a job name, plate number, and the like) on a non-processing printing plate after exposure.

Presensitized (PS) plates are commonly employed as printing plates on offset presses and they consist of two types, positive-working PS plates and negative-working PS plates. The following description assumes the negative-working PS plate but the present invention is by no means limited to this particular type of PS plate.

With the recent technological advances in general, the field of offset printing technology is also seeing improvements for simpler handling, environmental protection and other considerations by rendering PS plates to be of a non-processing type (eliminating the need to perform wet development on PS plates after exposure) so that they are suitable for use on computer-to-plate (CTP) platemaking equipment and a (digital) platemaking/printing system which performs platemaking and printing operations with the same equipment.

With such CTP platemaking equipment and platemaking/printing system, image can be recorded or formed in an assured way by means of exposure based on digital image data, so the image to be recorded is verified by proofing, i.e., displaying the image data on a display device or the like, with occasional omission of plate checking, or the verification of the image formed on the printing plate by imagewise exposure.

However, in the printing process, considering the needs to perform long-run print production with the printing plate of interest and to achieve correct verification of print defects and the like, plate checking is often required to be performed prior to long-run print production by verifying the image formed on the physically produced printing plate.

To this end, it is required with the conventional platemaking apparatuses, as well as with the above-mentioned CTP platemaking equipment and platemaking/printing system that plate checking be performed on a physically produced printing plate as it emerges from the last step of the platemaking process, with care being taken to prevent the entrance of unwanted foreign matter such as dust. With a view to meeting this requirement, it has been proposed that plate checking be performed by a method in which the printing plate as it emerges from the last step in the platemaking process is read with a scanner at substantially the same resolution as the recording image data used in the exposing step and then the thus read image data is compared with the original recording image data (see JP 2002-287322 A).

Speaking of the effort for rendering PS plates to be of a non-processing type, it will prove reasonably effective for the intended purposes including simpler handling and environmental protection, but it is not without problems for operators on the site.

In the case of conventional printing plates which are supposed to receive wet development processing, part of the colored light-sensitive layer is removed by development after exposure and the surface of the substrate such as an aluminum plate becomes bare, so the image formed on the printing plate can be visually checked to a reasonable extent.

Printing plates designed for exposure to ultraviolet rays are another conventional example in extensive use and with this type of printing plates, the visible range also experiences a change in absorption spectrum upon exposure, so the human eye suffices to check for the occurrence of the change.

By contrast, printing plates for on-press development processing and “non-processing” printing plates such as fully non-processing ones are not subjected to conventional procedures of wet development processing after they are exposed by an exposing apparatus.

Hence, some of the non-processing printing plates which are not supposed to receive wet development processing have a disadvantage in that given only exposure, it is difficult to perform visual plate checking on account of the small difference in image density between the exposed area and the non-exposed area.

To be more specific, some of the non-processing printing plates that have sensitivity in the invisible range and which do not experience an absorption spectrum change in the visible range, except in the case where the above-described printing plates which are designed for exposure to ultraviolet rays are applied as non-processing printing plates, will produce little difference in color or density after image formation and this causes difficulty in image verification (plate checking).

Conventionally, plate checking of printing plates is performed not for determining the quality of the image on the printing plate but more often than not, the primary purpose has been to use the result just as information that helps evaluate the overall quality of the printing plate as produced or to check the register marks and printing plate identifying information that have been recorded on the plate. Nevertheless, a serious trouble may occur if the plate cannot be read with a certain degree of clarity.

Take, for example, the case of evaluating the overall quality of the printing plate as produced. If the printing plate is of a non-processing type in which the exposed and non-exposed areas do not have a color or density difference that is great enough to enable visual plate checking, only unclear reading is possible but this does not suffice for the purposes of making a check prior to long-run print production by the plate and performing accurate verification of print defects or the like.

One might think of dealing with this problem by applying the technology disclosed in JP 2002-287322 A, supra; however, this technology, even if it is employed for the conventional platemaking apparatuses, as well as for the above-mentioned CTP platemaking equipment and platemaking/printing system, does no more than reading the image on the printing plate with a scanner as it emerges from the last step in the platemaking process.

In other words, the scanner used in the technology under consideration simply reads the image on the physically produced printing plate as image data on the basis of the density or color difference between the image and non-image areas, namely on the basis of the difference in the absorption spectrum in the visible range; therefore, if the printing plate is of a non-processing type which has no color or density difference between the exposed and non-exposed areas, the technology is incapable of reading the image from the exposed or non-exposed area.

In addition, in this technology it is after the last step in the platemaking process that the image on the printing plate is read with the scanner; the printing plate carrying the image to be read is such that the image area which has been either exposed or left unexposed is fixed either completely or partially and the image to be read is not one being formed during the exposing step in the platemaking process, certainly not an image on the printing plate in the as-exposed area. Therefore, the scanner used in the technology under consideration is not supposed to, or has no ability to, read the image on the printing plate during the exposing step, still less the image in the as-exposed area; even if the scanner disclosed in that technology is used to read the image (either in the exposed or unexposed area) on the printing plate as it emerges from the exposing step, the area which should be left unexposed is exposed.

Further in addition, the register marks and the printing plate identifying information that are recorded on the printing plate discussed above are difficult for the operator to know the positions where they are located if the printing plate is of a non-processing type which has no color or density difference between the exposed and non-exposed areas. Compared to the above-described image which is used as information that helps evaluate the overall quality of the printing plate as produced, the register marks require clearer indication of their positions since engaging holes that help the printing plate to be set on a press are bored in registry with those marks; this is also true with the printing plate identifying information and unless it can be read clearly enough, a serious trouble will occur to the performance of the operations.

To solve these problems, reference may be made to the technology disclosed in JP 10-67087 A which is an improved platemaking method comprising the steps of coating a surface plate with an original film, exposing the film and developing it by a wet process. Conventionally, scumming has occurred when register marks are drawn with a scriber before development or before exposing or after exposing but before development; in order to solve this problem, register marks that are insoluble in the developer are drawn on the printing plate by means of an ink jet printer.

However, the technology under consideration is to be applied to the conventional printing plates which are supposed to be produced by a process comprising the steps of coating a surface plate with an original film, exposing the film and developing it by a wet process, and the non-processing printing plate is not what the technology is to be applied to. In addition, forming register marks that can be read clearly enough is not the objective of the technology.

As a result, the technology does no more than recording register marks with an ink jet using a dedicated register mark drawing apparatus that is completely separate from the exposing apparatus and it has the disadvantage that register marks, printing plate identifying information and the like cannot be recorded during the exposing step.

### SUMMARY OF THE INVENTION

The present invention has been accomplished under these circumstances and has as its first object solving the above-described problems of the prior art by providing a method and apparatus for producing printing plates which is characterized in that so-called “non-processing” printing plates which are not supposed to receive wet development processing, in particular, those that form an invisible image which is difficult to check visually, for example, “non-processing” printing plates for exposure to infrared rays are so designed as to allow for easy and positive plate checking and that they can be produced with high efficiency.

The second object of the present invention is to solve the aforementioned problems of the prior art by providing a method and apparatus for producing printing plates which is characterized in that “non-processing” printing plates which are not supposed to receive wet development processing are improved with respect to the method of forming register marks and printing plate identifying information on the plate so as to allow for easy and positive plate checking and that they can be produced with high efficiency.

In order to attain those two objects, the present inventors conducted intensive studies about the way to produce “non-processing” printing plates that do not require wet development processing and which yet will allow for easy and positive plate checking. As a result, the inventors found the following: unlike the printing plates designed for exposure to ultraviolet rays which conventionally are in extensive use, the printing plates designed for exposure to infrared rays get the absorption spectrum to change in the infrared range upon exposure; since the infrared range is outside the range where the human eye has sensitivity (luminosity factor), the change in absorption spectrum is difficult to identify; therefore, if the printing plate that will form an image from the exposed area where a spectral absorption change has occurred in an invisible range such as the infrared range is exposed while at the same time the spectral absorption change in the exposed area is read and reconstructed as a visible image, which is outputted and displayed, for example, on an image display device, plate checking can be effected by the operator who evaluates the overall quality of the printing plate as produced, for the purpose of checking prior to long-term print production using the same printing plate and for accurate verification of print and other defects. The inventors also found the following: if information that needs to be read in a subsequent printing step is recorded with an ink jet in the area of the printing plate where imagewise exposure has ended, plate checking can be effected by the operator who determines the positions at which the information such as register marks and printing plate identifying information that will be needed in the subsequent printing step were recorded. The present invention has been accomplished on the basis of those findings.

That is, in order to attain the first object described above, a first aspect of the present invention provides a process for producing a printing plate without wet development processing, comprising the steps of: exposing a printing plate so that an image is formed on the printing plate from an exposed area which has got a spectral absorption change to occur in an invisible range; as well as reading the spectral absorption change in the invisible range that has occurred in the exposed area of the printing plate; reconstructing as a visible image the image formed by the thus read spectral absorption change in the invisible range that occurred in the exposed area; and outputting the thus reconstructed visible image.

Here, preferably, the printing plate has an image forming layer which, upon irradiation with light having a wavelength in the invisible range, causes the spectral absorption change to occur in the invisible range and is exposed to the light having the wavelength in the invisible range.

And, preferably, the invisible range is an infrared range.

Further, preferably, the exposing step of the printing plate is performed simultaneously with the reading step of the spectral absorption change in the exposed area of the printing plate, and the spectral absorption change in the exposed area that occurs immediately after exposure is read.

And further, preferably, a first width of exposure in the exposing step of the printing plate is generally equal to a second width of reading from the printing plate in the reading step and a first number of pixels to be exposed in the exposing step of the printing plate is approximately an integral multiple of times a second number of pixels to be read from the printing plate in the reading step.

In order to attain the second object described above, a second aspect of the present invention provides a process for producing a printing plate without wet development processing, comprising the steps of: exposing a printing plate so that an image is formed on the printing plate from an exposed area which has got a spectral absorption change to occur in an invisible range; as well as drawing information that needs to be read in a subsequent printing step on an area of the printing plate where the exposing step has ended with an ink jet.

Preferably, the information contains at least register marks.

Preferably, the printing plate has an image forming layer which, upon irradiation with light having a wavelength in the invisible range, causes the spectral absorption change to occur in the invisible range and is exposed to the light having the wavelength in the invisible range.

Preferably, the invisible range is an infrared range.

Preferably, the exposing step of the printing plate is performed simultaneously with the drawing step of the information by the ink jet, and the information is drawn with the ink jet in the area where the exposing step has just ended.

And, preferably, a first width of exposure in the exposing step of the printing plate is generally equal to a third width of drawing the information with the ink jet on the printing plate in the drawing step and a first number of pixels to be exposed in the exposing step of the printing plate is approximately an integral multiple of times a third number of pixels in the formation to be drawn with the ink jet on the printing plate in the drawing step.

Moreover, in order to attain the first object described above, a third aspect of the present invention provides an apparatus for producing a printing plate without wet development processing, comprising: exposing means which exposes a printing plate to form an image on the printing plate from an exposed area which has got a spectral absorption change to occur in an invisible range; reading means which reads the spectral absorption change in the invisible range that has occurred in the exposed area of the printing plate; image reconstructing means which reconstructs as a visible image the image formed by the thus read spectral absorption change in the invisible range that occurred in the exposed area; and output means for outputting the thus reconstructed visible image.

Here, preferably, the exposing means and the reading means move in synchronism.

And, preferably, the reading means has a reading light source, image focusing optics and imaging means, the reading light source issuing light that has a wavelength in the invisible range and which does not cause the spectral absorption change to occur in the printing plate, the image focusing optics allowing the spectral absorption change in the exposed area of the printing plate to form a focused image on the imaging means, and the imaging means having sensitivity in the invisible range and detecting the spectral absorption change in the exposed area of the printing plate as image data.

Preferably, the printing plate has an image forming layer which, upon irradiation with light having a wavelength in the invisible range, causes the spectral absorption change to occur in the invisible range and is exposed to the light having the wavelength in the invisible range.

Preferably, a first width of exposure of the printing plate with the exposing means is generally equal to a second width of reading from the printing plate with the reading means and a first number of pixels to be exposed in the exposure of the printing plate with the exposing means is approximately an integral multiple of times a second number of pixels to be read from the printing plate with the reading means.

And, preferably, the invisible range is an infrared range.

In order to attain the second object described above, a fourth aspect of the present invention provides an apparatus for producing a printing plate without wet development processing, comprising: exposing means which exposes a printing plate to form an image on the printing plate from an exposed area which has got a spectral absorption change to occur in an invisible range; and ink-jet drawing means for drawing information that needs to be read in a subsequent printing step on an area of the printing plate where the exposing step has ended with an ink jet.

Here, preferably, the information contains at least register marks.

And, preferably, the exposing means and the ink-jet drawing means move in synchronism.

Preferably, the printing plate has an image forming layer which, upon irradiation with light having a wavelength in the invisible range, causes the spectral absorption change to occur in the invisible range and is exposed to the light having the wavelength in the invisible range.

Further, preferably, the invisible range is an infrared range.

Preferably, the ink-jet drawing means has a plurality of ink-jet nozzles, and the exposing means adopts a multi-beam exposing system.

And, preferably, a first width of exposure in the exposing step of the printing plate is generally equal to a third width of drawing the information on the printing plate with the ink-jet drawing means and a first number of pixels to be exposed in the exposure of the printing plate with the exposing means is approximately an integral multiple of times a third number of ink-jet nozzles in the ink-jet drawing means.

Thus, the essence of the first and the third aspects of the present invention lies in “reading the exposed area for forming an image on the printing plate where the change in spectral absorption is at least in the invisible range” and the exposing and reading actions are preferably performed simultaneously so as to read the spectral absorption change in the exposed area which occurs immediately after the exposure. Note that the wavelength of the exposing light may be chosen as appropriate for the characteristics of the printing plate. The wavelength of the exposing light does not necessarily have to be equal to that of the reading light but the two wavelengths are preferably equal.

The first and the third aspects of the present invention offer a significant advantage in that they can realize a method and apparatus by which “non-processing” printing plates such as those having an invisible image formed thereon, in particular, “non-processing” printing plates for exposure to infrared rays that are designed to allow for easy and positive plate checking, can be produced with high efficiency.

More specifically, an image formed on the printing plate from the exposed area which has got a spectral absorption change to occur in the invisible range, for example, an invisible image produced on the printing plate as a result of image formation by light, such as infrared light, which is inherently in the invisible range is reconstructed as an image that can be recognized by the operator (i.e., as a visible image), and this offers the advantage of allowing for easy checking of the printing plate.

In addition, the second and the fourth aspects of the present invention offer a significant advantage in that they can realize a method and apparatus by which “non-processing” printing plates that are improved with respect to the method of recording register marks and printing plate identifying information on the plate so as to allow for easy and positive checking of those printing plates which inherently have little difference in color or density, can be produced with high efficiency.

### BRIEF DESCRIPTION OF THE DRAWINGS

FIG. 1 is a top view showing the layout of the essentials in an apparatus for producing printing plates according to the first embodiment of the present invention;

FIG. 2 is a graph showing a profile of absorption spectra vs. exposure intensity (amount of exposure) for a PS plate that can be suitably used on the printing plate producing apparatus depicted in FIG. 1;

FIG. 3 is an operational flow chart for an exposing/reading control section which shows the characteristic operations of the printing plate producing apparatus depicted in FIG. 1;

FIG. 4 is a top view showing the layout of the essentials in an apparatus for producing printing plates according to the second embodiment of the present invention; and

FIG. 5 is an operational flow chart for an exposing/drawing control section which shows the characteristic operations of the printing plate producing apparatus depicted in FIG. 4.

### BEST MODES FOR CARRYING OUT THE INVENTION

The method and apparatus for producing printing plates according to the present invention are described below in detail on the basis of the preferred embodiments shown in the accompanying drawings.

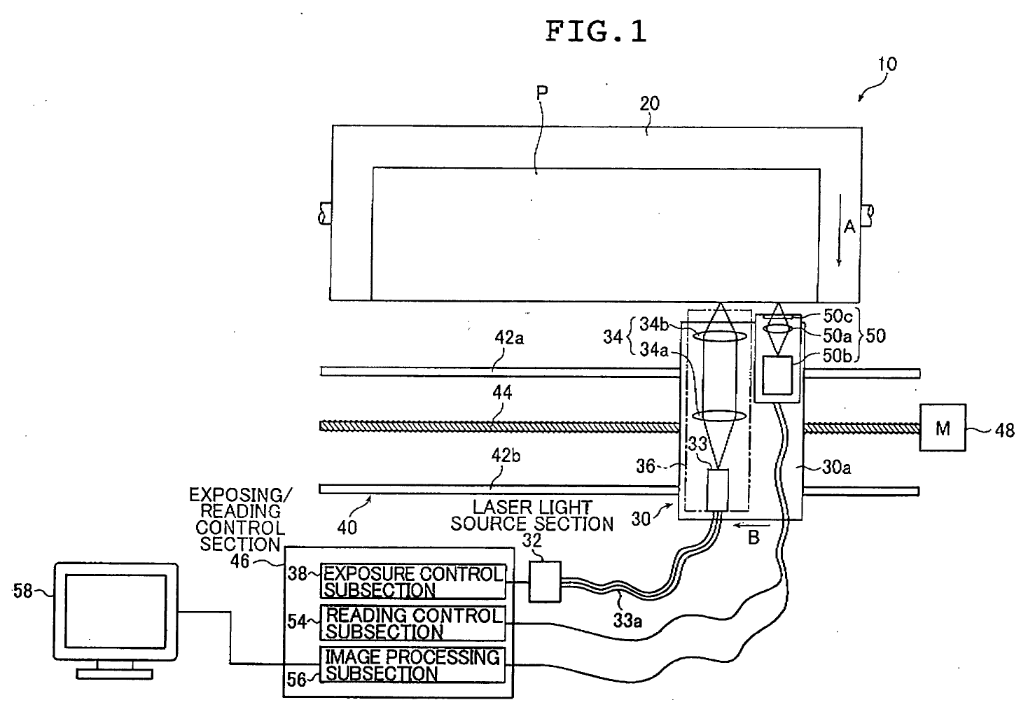

First of all, by referring to FIGS. 1-3, let us describe the first embodiment of the present invention which is an apparatus for producing printing plates as the third aspect of the present invention which is used to implement a method of producing printing plates as the first aspect of the invention.

### FIRST EMBODIMENT

FIG. 1 is a top view showing the layout of the essentials in an apparatus for producing printing plates according to the first embodiment of the present invention.

The printing plate producing apparatus according to the first embodiment is generally indicated by 10 and has an outer drum 20 for holding a so-called “non-processing” PS plate P which does not require wet development processing (and which is hereunder referred to simply as a PS plate P) and an exposing/reading head 30 which not only performs imagewise exposure on the PS plate P held on the outer drum 20 for a specified image to be recorded but which also reads an image formed from the exposed area of the PS plate P that has been subjected to imagewise exposure.

The printing plate producing apparatus 10 has the following additional components: a laser light source section 32 from which laser light (laser beam) modulated in accordance with the specified image to be recorded is transmitted to the exposing/reading head 30, an exposing/reading control section 46 which controls the exposing and reading actions of the laser light source section 32 and the exposing/reading head 30, and an image display device 58 which is connected via the exposing/reading control section 46 to display on a display screen the image that has been formed from the exposed area and read by the exposing/reading head 30.

As is well known, the outer drum 20 consists of a rotating drum having on its surface a plurality of members (not shown) for engaging the PS plate P and in the first embodiment under consideration, the direction in which the outer drum 20 rotates coincides with the main scanning direction for performing the exposing and reading actions (as indicated by arrow A in FIG. 1). In other words, the rotation of the outer drum 20 causes main scanning as the exposing/reading head 30 performs the exposing and reading actions. It should also be noted here that in response to control signals (main scan timing signals) which come from the exposing/reading control section 46 to be described later, the rotation of the outer drum by means of a rotational drive source (not shown) is controlled to thereby control the main scanning as the exposing/reading head 30 performs the exposing and reading actions.

The exposing/reading bead 30 is so adapted that it is capable of reciprocating over a guide mechanism 40 along the surface of the above-described outer drum 20 in its axial direction. The guide mechanism 40 is composed of a ball screw 44 and guide rails 42a and 42b which are provided parallel to the outer drum 20. In the first embodiment under consideration, one of the directions in which the exposing/reading head 30 reciprocates coincides with the auxiliary scanning direction (which is indicated by arrow B in FIG. 1).

The exposing/reading head 30 consists an exposing head 36 and a reading head 50. The exposing head 36 comprises a fiber array 33 and an image focusing optical system 34, and functions to perform imagewise exposure on the PS plate P held on the surface of the outer drum 20 using laser light that has been modulated with the image data in the laser light source section 32 and transmitted as issued therefrom; the reading head 50 and the exposing head 36 are commonly placed on a moving base 30a, and comprising an image focusing optical system 50a, a CCD 50b and a reading illuminating light source 50c, the reading head 50 functions to read the image on the PS plate P which has been formed of the exposed area by the exposing head 36.

In the first embodiment, the exposing head 36 may suitably be of the same type as a well-known multi-beam exposing device (see, for example, commonly assigned JP 2003-21912 A). In the first embodiment under consideration, the exposing head 36 has a density of 2400 dpi (which is equivalent to about 10.6 μm in pixel size).

Also note that the laser light as transmitted from the laser light source section 32 and issued from the exposing head 36 to expose the PS plate P needs to have such capability that upon illumination with it, the PS plate P (specifically, its image forming layer (light-sensitive layer)) is allowed to have a spectral absorption change at least in an invisible range, namely, the infrared or ultraviolet range, preferably in the infrared range; therefore, it is laser light containing wavelength components at least in those invisible ranges. Laser light suitable for use in the present invention may contain a wavelength component spanning the visible and invisible ranges or it may contain a wavelength component only in the invisible range.

The wavelength component to be possessed by the laser light which is applied to expose the PS plate P is not limited in any particular way and may appropriately be chosen depending on the exposure characteristics of the PS plate P, say, the change in spectral absorption with the wavelength at which the PS plate P is exposed, namely, the relationship between the exposing wavelength and the difference in absorption spectrum between non-exposure and the case of exposure to a specified amount of energy.

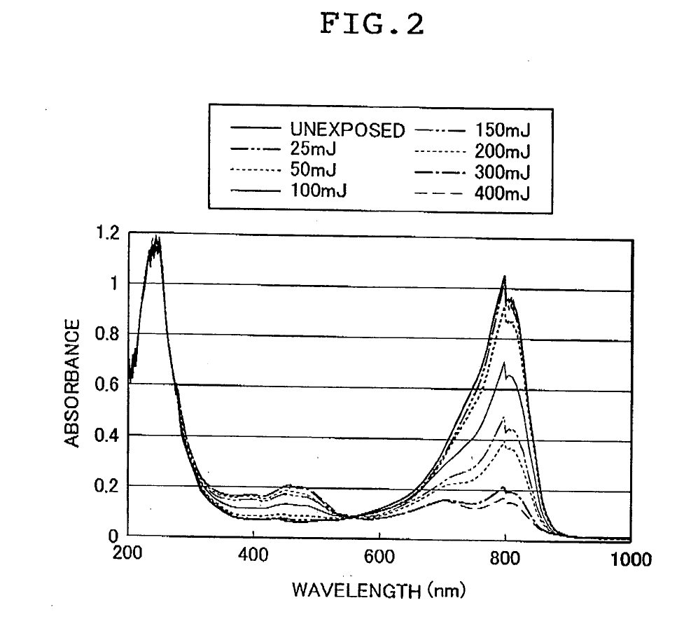

Take, for example, a PS plate P having the absorbance vs. wavelength profile shown in FIG. 2. As will be discussed more specifically below, this plate shows an absorption peak around 800 nm and in that peak area, it experiences large enough changes in absorption spectrum between non-exposure and the case of exposure at energies of 100 mJ and higher. Therefore, the laser light to be applied to expose the PS plate P is required to contain a wavelength range at least around 800 nm and have the energy necessary to effect exposure in that wavelength range; preferably, it is laser light having a central wavelength between 800 nm and 830 nm.

Turning to the reading head 50, it is preferably of such a type that the image focusing optical system 50a which is also known is used to focus on the CCD 50b the image to be read that has been formed from the area of the PS plate P as exposed by the exposing head 36 and which has been illuminated with the reading illuminating light source 50c.

In this case, the width of reading with the reading head 50 may be adjusted to be equal or generally equal to the width of swathing (exposing) with the exposing head 36 and in order to suppress uneven reading, the number of pixels to be exposed with the exposing head 36 may be adjusted to be an integral multiple times or approximately an integral multiple of times the number of pixels to be read with the reading head 50, namely, the number of dots to be photo-detected with the CCD 50b (in other words, the number of pixels to be read with the reading head 50, namely, the number of dots to be photo-detected with the CCD 50b may be adjusted to be an integral multiple of times or approximately an integral multiple of times less than the number of pixels to be exposed with the exposing head 36); this is preferred since it provides ease in controlling the positions of exposing and reading with the exposing/reading head 30. Take, for example, the case of using a 128-channel head as the exposing head 36 to expose pixels at a density of 2400 dpi (which is equivalent to about 10.6 μm in pixel size); if the reading head 50 is assumed to read pixels at a density of 600 dpi (which is equivalent to about 42.3 μm in pixel size), the number of dots to be photo-detected with the CCD 50b may be adjusted to 32 channels and the number of pixels to be read (or the density at which they are read) with the reading head 50 may be adjusted to one-fourth the number of pixels to be exposed (or the density at which they are exposed) or, alternatively, the number of dots to be photo-detected with the CCD 50b may be adjusted to one-fourth the number of exposing channels.

In the embodiment under consideration, the reading illuminating light source 50c which illuminates the image to be read after exposure by the exposing head 36 is of such a type that the PS plate P which has been illuminated with the laser light from the exposing head 36 to form an exposed area having a spectral absorption change in the invisible wavelength range is illuminated with that reading illuminating light source 50c without causing any further spectral absorption change in the same invisible wavelength range; therefore, the reading illuminating light source 50c may be of a type that issues illuminating light that contains at least the invisible wavelength range in which the spectral absorption change has occurred; on the other hand, the quantity of illuminating light issued from the light source 50c, which is insufficient to get the exposed area of the PS plate P to have a spectral absorption change in the invisible wavelength range upon illumination with that illuminating light, must be large enough to allow its detection with the CCD 50b.

The reading illuminating light source 50c may be of any type that can issue illuminating light that has a wavelength range containing the invisible wavelength range in which the PS plate P has experienced a spectral absorption change, for example, the infrared or ultraviolet range, preferably the infrared range; the light source 50c may be of a type that issues illuminating light containing a wavelength component spanning the visible and invisible ranges or it may be of a type that issues illuminating light containing a wavelength component only in the invisible range.

The wavelength component to be possessed by the illuminating light from the reading illuminating light source 50c which is used to illuminate the exposed area of the PS plate P is not limited in any particular way and may appropriately be chosen depending on the exposure characteristics of the PS plate P (see the relevant description about the laser light used to expose the PS plate P) and on the exposing laser light that has been set depending on such exposure characteristics.

Take, for example, a PS plate P having the absorbance vs. wavelength profile shown in FIG. 2. As already discussed above, if the laser light used to expose the PS plate P contains a wavelength range at least around 800 nm, preferably having a central wavelength between 800 nm and 830 nm, and has the energy necessary to effect exposure in that wavelength range, the illuminating light from the reading illuminating light source 50c preferably has the same wavelength range, in which it has an energy that is smaller than is required for exposure but large enough to allow for detection with the CCD 50b.

Speaking now of the CCD 50b, it is a line image sensor that receives the light reflected from the PS plate P after it has been illuminated with, for example, the illuminating light issued from the reading illuminating light source 50c, to thereby detect the spectral absorption change the exposed area of the PS plate P has experienced in the invisible wavelength range. Therefore, the CCD 50b may be of any type that can detect such spectral absorption change, namely, any type that has sensitivity to the invisible wavelength range in which the exposed area of the PS plate P has experienced the spectral absorption change. Accordingly, the CCD 50b may be of a type that has sensitivity to a wavelength component spanning the visible and invisible ranges or it may be of a type that has sensitivity to a wavelength component which is only within the invisible range; the wavelength range in which the CCD 50b has sensitivity is not limited in any particular way and may appropriately be chosen depending on the exposure characteristics of the PS plate P and on the exposing laser light and the illuminating light that have been set depending on such exposure characteristics.

Take, for example, a PS plate P having the absorbance vs. wavelength profile shown in FIG. 2. If the laser light used to expose the PS plate P and the illuminating light from the reading illuminating light source 50c each contain a wavelength range at least around 800 nm, preferably a wavelength range having a central wavelength between 800 nm and 830 nm, the CCD 50b preferably has the same wavelength range in which it receives the light reflected from the PS plate P after it has been illuminated with the illuminating light from the reading illuminating light source 50c, to thereby detect the spectral absorption change the exposed area of the PS plate P has experienced in the invisible wavelength range.

Turning back to FIG. 1, we continue to explain the first embodiment of the present invention.

The guide mechanism 40 for the exposing/reading head 30 is for moving the exposing/reading head 30 in the auxiliary scanning direction so that it performs auxiliary scanning during its exposing and reading actions; the guide mechanism 40 consists of the ball screw 44 and the guide rails 42a and 42b, each being provided parallel to the above-described outer drum 20, as well as a rotational drive source 48 for the ball screw 44 (which consists of a motor M and a transmission mechanism). To state more specifically, the exposing/reading head 30 has a female screw element (not shown) in threadable engagement with the bail screw and sliders (not shown) that fit over the guide rails to be slidable along them, both the female screw element and the sliders being mounted on the back side of the moving base 30a. In response to control signals (auxiliary scan timing signals) coming from the exposing/reading control section 46 to be described later, the rotation of the ball screw 44 by means of the rotational drive source 48 is controlled, whereby the movement of the base 30a is controlled, which in turn controls the movement of the exposing/reading head 30 in the auxiliary scanning direction.

Laser light as modulated in the laser light source section 32 on the basis of modulation signals in accordance with the image data from an exposure control sub-section 38 provided in the exposing/reading control section 46 to be described later is transmitted through a fiber bundle 33a to the fiber array 33 in the exposing head 36; carrying the image to be recorded, the received laser light is projected through the image focusing optical system 34 consisting of a collimator lens 34a and an image focusing lens 34b, whereupon it is focused on the PS plate P around the outer drum 20 to expose it.

The reading head 50 is mounted on the base 30a which is also the base for the exposing head 36 and its operation is controlled by a reading control sub-section 54 which is in the exposing/reading control section 46 to be described later and which holds information about predetermined reading positions.

The exposing/reading control section 46 under consideration has such a function that it causes the exposing head 36 and the reading head 50 to be driven substantially at the same time. To be more specific, the exposing/reading control section 46 controls the printing plate producing apparatus 10 in such a way that a single PS plate P is subjected to imagewise exposure by the exposing head 36 in predetermined positions while at the same time the exposed image is read by the reading head 50 in positions which are also predetermined. Thus, in the first embodiment shown in FIG. 1, the exposing/reading control section 46 preferably controls the actions of the exposing head 36 and the reading head 50 in such a way that at the time when the position of the area as exposed by the exposing head 36 moving in the auxiliary scanning direction coincides with the position of reading with the reading head 50 which is mounted on the same base 30a and likewise moving in the auxiliary scanning direction, the reading head 50 starts the reading action so that the exposing action of the exposing head 36 is performed simultaneously with the reading action of the reading head 50.

It is also preferred that the exposing/reading control section 46 controls the reading head 50 to read the exposed image over the same width as the swathing width (exposure width) over which the exposing head 36 performs imagewise exposure. However, this is not the sole case of the present invention and the exposing/reading control section 46 may control the reading head 50 to read the exposed image over a different width than the swathing width (exposure width).

As described above, the exposing/reading control section 46 not only functions to control the rotation of the outer drum 20 in the main scanning direction and the movement of the exposing/reading head 30 (or the base 30a) in the auxiliary scanning direction as it carries the exposing head 36 and the reading head 50, but it also functions to control the overall operations of the printing plate producing apparatus 10. In particular, for the purpose of recording an image on the PS plate P by means of the exposing head 36 and the reading head 50, the exposing/reading control section 46 has the functions of controlling various operations such as exposure, reading of the exposed image, and reconstruction of the thus read image into a visible image.

To this end, the exposing/reading control section 46 has the exposure control sub-section 38 which controls the exposing action of the laser light source section 32 and the exposing head 36, the reading control sub-section 54 which controls the reading action of the reading head 50, and an image processing sub-section 56 in which the invisible image read by the reading head 50 is constructed as a visible image.

In the reading head 50, the CCD 50b performs photoelectric conversion of reflected light from the PS plate P as it carries the image illuminated with the reading illuminating light source 50c and focused by the image focusing optical system 50a; the electric signal is then passed through an A/D transducer section (not shown) so that it is converted to digital data, which is then supplied to the image processing sub-section 56. Briefly, under the control of the reading control sub-section 54, the reading head 50 reads the invisible image on the PS plate P and supplies it to the image processing sub-section 56.

In the image processing sub-section 56, the supplied digital data receives predetermined corrections, is converted to digital image data for the image reconstructed as a visible image, and eventually supplied to the image display device 58 as visible image data.

The image display device 58 displays a visible image on the display screen (monitor screen) on the basis of the supplied visible image data.

Adopting the above-described configuration, the printing plate producing apparatus 10 assures that the invisible image formed on the PS plate P by means of the exposing head 36 is reconstructed as a visible image that can be recognized by the operator and which is then displayed on the image display device 58.

FIG. 2 is a graph showing the profile of absorption spectra vs. exposure intensity (amount of exposure) for the printing plate (PS plate) P that can be suitably used on the printing plate producing apparatus according to the first embodiment of the invention (for details of the method of making the plate, see the Examples that follow).

As is clear from FIG. 2, the PS plate P under consideration has an absorption spectrum peak at around 800 nm on the longer wavelength side (IR, or infrared range) and in the neighborhood of that wavelength, significant changes occur in the absorption spectrum (drops in absorbance) after exposure with respect to the intensity of exposure (amount of exposure); for example, a significant difference is observed between the absorbance for non-exposure (indicated by the thick solid line) and the absorbance for exposure at an exposing energy of 100 mJ (indicated by the thin solid line).

By contrast, the PS plate P has an absorption peak at around 250 nm on the shorter wavelength side (UV, or ultraviolet range) but in the neighborhood of that wavelength, hardly any change occurs in the absorption spectrum after exposure with respect to the intensity of exposure (amount of exposure).

In the visible range, particularly at wavelengths around 400-500 nm, slight changes are observed in the absorption spectrum after exposure (rise in absorbance) but the differences in those changes are insufficient to allow for visual checking of register marks and printing plate identifying information and accurate check is difficult to realize. To deal with this difficulty, image reading is performed on the longer wavelength side (IR, or infrared range), namely, by means of infrared light as shown in the embodiment under consideration and the intended beneficiary effect is exhibited.

Details of this operation are given hereinafter.

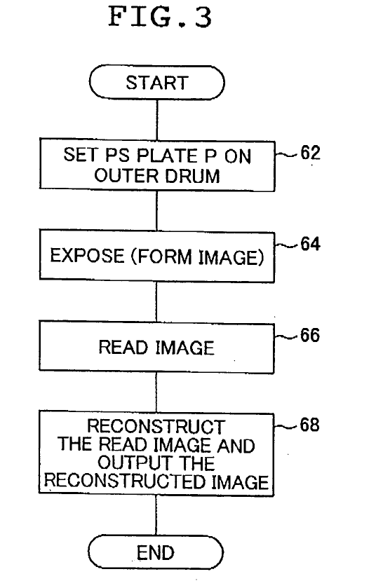

FIG. 3 is an operational flow chart for the exposing/reading control section 46 which shows the characteristic operations of the printing plate producing apparatus 10 according to the first embodiment for the purpose of illustrating how the above-mentioned operations are performed. Remember that the exposing/reading control section 46 in fact has the exposure control sub-section 38 which controls the exposing action of the laser light source section 32 and the exposing head 36, the reading control sub-section 54 which controls the reading action of the reading head 50, and the image processing sub-section 56 in which the invisible image as read by the reading head 50 is reconstructed as a visible image.

The printing plate producing apparatus 10 performs such characteristic actions that the invisible image formed by the exposing action of the exposing head 36 is read with the reading head 50 and thereafter reconstructed on the display screen of the image display device 58 as a visible image that can be recognized by the operator. Thus, in the printing plate producing apparatus 10, the invisible image on the printing plate that has been exposed to light containing at least light in the invisible range, such as infrared light, is reconstructed as an image that can be recognized by the operator, and this allows for easy checking of the printing plate.

As depicted in FIG. 3, the operation of the printing plate producing apparatus 10 comprises the following steps: first, the PS plate P is set on the outer drum 20 (step 62); then, the PS plate P is exposed by means of the laser light source section 32 and the exposing head 36 to get the absorption spectrum in the invisible range to experience a change so that an invisible image is formed on the PS plate (step 64); subsequent to this exposing (image forming) step, the formed invisible image is read with the reading head 50 (step 66); the image thus read is reconstructed as a visible image, which is displayed as appropriate on the display screen of the image display device 58 (step 68).

As for the relation between the times at which the exposing (image forming) step (step 64) and the image reading step (step 66) start to be executed, namely, the timings of starting the respective actions, it is preferred that the image reading step (step 66) is started at a specified time after the point in time when the exposing (image forming) step (step 64) was started. If desired, the image reading step (step 66) may be started after the exposing (image forming) step (step 64) was completed.

Note that, in the first embodiment shown in FIG. 1, it is preferred that at the time when the position of the area as exposed by the exposing head 36 moving in the auxiliary scanning direction coincides with the position of reading with the reading head 50 which is mounted on the same base 30a and likewise moving in the auxiliary scanning direction, the reading head 50 starts the reading action so that the exposing action of the exposing head 36 is performed simultaneously with the reading action of the reading head 50.

In the embodiment under consideration, image reading by the reading head 50 may cover the entire area where the image was formed by the exposing head 36; alternatively, the reading head 50 may read only designated areas of the image as formed by the exposing head 36. All that is required is to get a sufficient size (area) of image to evaluate the quality of the image formed on the PS plate P by exposure.

On the following pages, examples are provided to show how to make PS plates that can be suitably applied to the printing plate producing apparatus according to the first embodiment of the present invention, as well as to describe the results of making printing plates using the PS plates.

### EXAMPLE 1

In this example, there was prepared a PS plate having an image recording layer containing microcapsules but which did not contain a print-out agent, nor did it have an overcoat layer (also called an oxygen barrier layer or OC layer).

(1) Preparing a Substrate

An aluminum plate 0.3 mm thick (made of the material specified in JIS 1050) had the rolling oil removed from the surface by degreasing with an aqueous solution of 10 mass % sodium aluminate at 50° C. for 30 seconds; thereafter, the aluminum surface was grained using three nylon brushes with embedded bundles of 0.3 mmΦ bristles and an aqueous suspension of pumice particles having a median diameter of 25 μm (specific gravity: 1.1 g/cm³) and then washed thoroughly with water. The thus treated aluminum plate was dipped for etching in an aqueous solution of 25% sodium hydroxide at 45° C. for 9 seconds, washed with water, then dipped in 20% nitric acid at 60° C. for 20 seconds, and again washed with water. The grained surface was found to have been etched in an amount of about 3 g/m².

In the next step, continuous electrochemical surface roughening was performed using an alternating voltage at 60 Hz. The electrolyte was an aqueous solution of 1 mass % nitric acid (containing 0.5 mass % of aluminum ions) at a temperature of 50° C. The AC supply produced an alternating current of trapezoidal waveform having a TP of 0.8 milliseconds (TP is the time it takes for the current to increase from zero until it reaches a peak) and a duty ratio of 1:1, and electrochemical surface roughening was performed using a carbon counter electrode. Ferrite was used as the auxiliary anode. The current density was 30 A/dm² in terms of a peak value and 5% of the current flowing from the supply was diverted to the auxiliary anode. The amount of electricity generated during electrolysis of nitric acid was 175 C/dm² for the case where the aluminum plate was used as the anode. After electrochemical surface roughening, the aluminum plate was washed with a spray of water.

Next, using an aqueous solution of 0.5 mass % hydrochloric acid (containing 0.5 mass % of aluminum ions) at a temperature of 50° C., electrochemical surface roughening was performed in the same manner as electrolysis of nitric acid, except that the amount of electricity was 50 C/dm² for the case where the aluminum plate was used as the anode. Thereafter, the aluminum plate was washed with a spray of water. The thus treated aluminum plate was provided with a DC anodized coat in an amount of 2.5 g/m² at a current density of 15 A/dm² using 15% sulfuric acid (containing 0.5 mass % of aluminum ions) as an electrolyte. The aluminum plate was then washed with water and dried to form a support A.

Subsequently, the aluminum plate was dipped for pore closing in a heated (75° C.) solution containing 0.1% sodium fluorozirconate and 1% sodium dihydrogenphosphate at a pH of 3.7 for 10 seconds.

In the next step, the aluminum plate was treated with an aqueous solution of 2.5 mass % sodium silicate at 30° C. for 10 seconds.

Measurement with a stylus having a diameter of 2 μm showed that the substrate had a center-line-average roughness (Ra) of 0.51 μm.

(2) Forming an Undercoat

The substrate prepared in the previous step was bar coated with a coating solution for undercoat (1) having the formulation set forth below; the substrate was then oven dried at 80° C. for 20 seconds to form an undercoat having a dry deposit of 0.005 g/cm².

Coating solution for undercoat (1)

| | |
|---|---|
| Water | 10 g |
| Methanol | 90 g |
| Polymer (1) of chemical formula 1 | 0.09 g |
| set forth below | |

Chemical formula 1

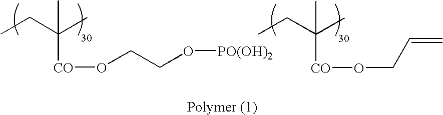

(3) Forming an Image Recording Layer

The undercoat formed in the previous step was bar coated with a coating solution for image recording layer (1) having the formulation set forth below; the substrate was then oven dried at 70° C. for 60 seconds to form a light-sensitive thermal layer having a dry deposit of 1.0 g/cm² to produce a PS plate for lithographic printing.

Coating solution for image recording layer (1)

| | |
|---|---|
| IR absorber (1) of chemical formula 2 | 0.3 g |
| (see below) | |
| Polymerization initiator (1) of chemical | 0.9 g |
| formula 3 (see below) | |
| Binder polymer (1) of chemical formula 4 | 1.8 g |
| (see below) | |
| Polymerizable compound | 2.0 g |
| Isocyanuric acid EO modified triacrylate | |
| (ARONIX M-315 of TOAGOSET CO., LTD.) | |
| Microcapsules (1) (see below) (in solids | 5.0 g |
| content) | |
| Fluorine containing surfactant (1) of | 0.1 g |
| chemical formula 5 (see below) | |
| Methyl ethyl ketone | 5 g |
| Methanol | 5 g |
| Water | 35 g |
| Propylene glycol monomethyl ether | 50 g |

Chemical formula 2

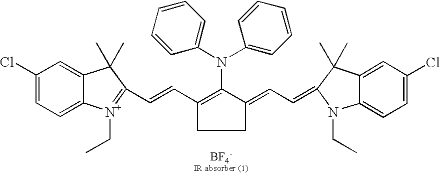

Chemical formula 3

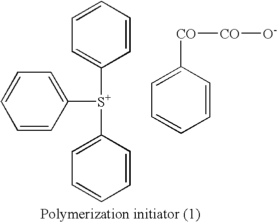

Chemical formula 4

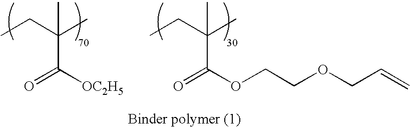

Chemical formula 5

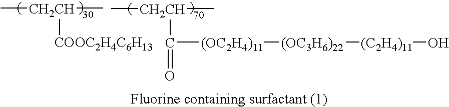

(Synthesis of Microcapsules (1))

As oil-phase ingredients, a trimethylolpropane/xylene diisocyanate adduct (8.7 g; Takenate D-110N of Mitsui Takeda Chemicals, Inc.), 2-methacryloyloxyethyl isocyanate (1 g; Karenz MOI of SHOWA DENKO K.K.), pentaerythritol triacrylate (3 g; SR444 of NIPPON KAYAKU CO., LTD.), Leuco Crystal Violet (3 g; product of Tokyo Kasei Kogyo Co., Ltd.), and a dodecylbenzenesulfonic acid Na salt (0.1 g; Pionin A-41C of TAKEMOTO OIL & FAT CO., LTD.) were dissolved in ethyl acetate (17 g).

As an aqueous-phase ingredient, an aqueous solution of 4 mass % PVA-205 was prepared in an amount of 40 g. The oil-phase ingredients were mixed with the aqueous-phase ingredient and the mixture was emulsified with a homogenizer at 12,000 rpm for 10 minutes. To the emulsified product, 25 g of distilled water was added and the mixture was stirred first at room temperature for 30 minutes, then at 40° C. for three hours. The thus obtained microcapsule solution was diluted with distilled water to adjust its solids content to 20 mass %. The microcapsules had an average particle size of 0.3 μm.

### EXAMPLE 2

In this example, there was prepared a PS plate having an image recording layer as a uniform film but which did not contain a print-out agent, nor did it have an OC layer.

A PS plate for lithographic printing was produced as in Example 1, except that the coating solution for image recording layer (1) was replaced by a coating solution for image recording layer (2) having the formulation set forth below and that the undercoat was bar coated with that coating solution (2) and oven dried at 100° C. for 60 seconds to form an image recording layer in a dry deposit of 1.0 g/m².

Coating solution for image recording layer (2)

| | | |
|---|---|---|
| IR absorber (1) of chemical formula 2 | 0.05 | g |
| (see above) | | |
| Polymerization initiator (1) of chemical | 0.2 | g |
| formula 3 (see above) | | |
| Binder polymer (1) of chemical formula 4 | 0.5 | g |
| (see above; av. mol. wt., 80,000) | | |
| Polymerizable compound | 1.0 | g |
| Isocyanuric acid EO modified triacrylate | | |
| (ARONIX M-315 of TOAGOSEI CO., LTD.) | | |
| Ethoxylated trimethylolpropane triacrylate | 0.2 | g |
| (SR9035 of NIPPON KAYAKU CO., LTD.; | | |
| 15 moles of ethylene oxide added) | | |
| Leuco Crystal Violet | 0.02 | g |
| (product of Tokyo Kasei Kogyo Co., Ltd.) | | |
| Fluorine containing surfactant (1) of | 0.05 | g |
| chemical formula 5 (see above) | | |
| Methyl ethyl ketone | 18.0 | g |

Each of the PS plates produced as described in Examples 1 and 2 was set on the outer drum 20 in the manner described above and subjected to image formation under infrared light by means of the exposing head 36; the image-carrying PS plate was not subjected to development processing but was immediately installed on the cylinder of SOR-M (printing press of Heidelberger Druckmaschinen AG). After supplying a fountain solution [EU-3 (liquid etchant of FUJI PHOTO FILM CO., LTD.)/water/isopropyl alcohol=1/89/10 (in volume ratio)] and black ink [TRANS-G (N) of DAINIPPON INK AND CHEMICALS, INCORPORATED), printing was done at a speed of 6,000 sheets per hour.

<Evaluating the Results of Printing Plate Production>

The number of printing sheets that were spent before the unexposed areas of the image recording layer had been removed from the printing press and the ink became no longer transferable to the printing sheets was counted as a measure of on-press developability. Whichever of the two PS plates described above was used, no more than 100 sheets were required before getting printed matter having no scum in the non-image area.

Printing was further continued and the impression capacity of the printing plates was evaluated in terms of runs that could be produced before the image area (the exposed areas of the image recording layer) had worn to cause reduced ink receptivity [i.e., the number of prints that could be obtained before the ink density (reflection density) had dropped by 0.1 from the initial value].

As it turned out, the results of producing printing plates according to the first embodiment of the present invention using the two PS plates of interest were very satisfactory. In addition, plate checking, the characteristic operation of the first embodiment of the present invention, was performed before the PS plates were installed on the printing press and the operation was smooth.

To be more specific, according to the first embodiment of the present invention, an invisible image on a printing plate formed by exposure to light having emission wavelengths in an invisible range such as the infrared range is reconstructed as a visible image that can be recognized by the operator and this offers a great practical benefit in that the printing plate can be checked very easily.

In the above-described first embodiment of the present invention, the exposing/reading head 30 has the exposing head 36 and the reading head 50 provided on the same base; if desired, the reading head 50 may be provided near the ejection port for the PS plate P so that image reading is effected at the point in time when the PS plate P is being ejected from the printing plate producing apparatus 10.

As described on the foregoing pages, the essence of the first embodiment of the present invention is that “an image on a printing plate that has been formed as a result of a spectral absorption change that is at least in an invisible range is read with an image sensor having sensitivity in the invisible range”; as long as the exposing light contains the invisible range, its wavelength can be chosen at any value that suits the characteristics of the printing plate, and although the wavelength of the exposing light does not necessarily have to be equal to that of the reading light, the two wavelengths are preferably equal or generally equal.

Thus, according to the first aspect of the present invention, the characteristics of printing plates (including their light sensitivity) can be designed from an extremely wide range and, what is more, a lot of advantages are brought about in the platemaking procedures adopting chosen characteristics, for example, in the method of handling the plates.

Described above are the basic features of the method of producing printing plates according to the first aspect of the present invention and the apparatus for producing them according to its third aspect.

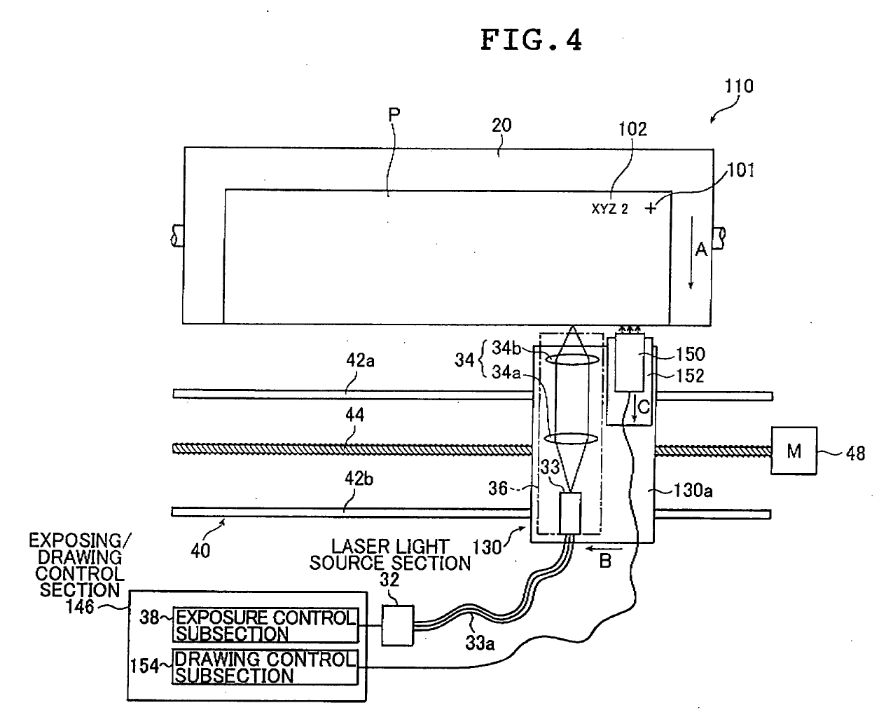

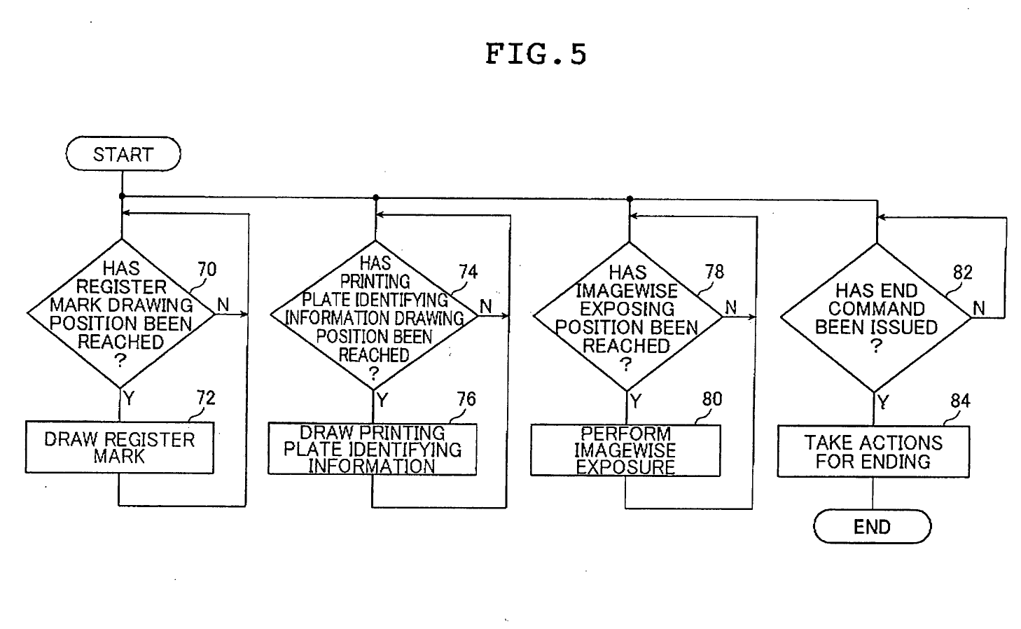

In the next place, by referring to FIGS. 4 and 5, we will describe the second embodiment of the present invention which is an apparatus for producing printing plates as the fourth aspect of the present invention which is used to implement a method of producing printing plates as the second aspect of the invention.

### SECOND EMBODIMENT

FIG. 4 is a top view showing the layout of the essentials in an apparatus for producing printing plates according to the second embodiment of the present invention.

The printing plate producing apparatus according to the second embodiment which is generally indicated by 110 in FIG. 4 has essentially the same configuration as the printing plate producing apparatus 10 according to the first embodiment which is shown in FIG. 1, except that it does not have the image display device 58 and that the exposing/reading head 30 and the exposing/reading control section 46 are replaced by an exposing/drawing head 130 and an exposing/drawing control section 146, respectively; therefore, like constituents are identified by like reference numerals and instead of describing them in detail, only the differences will be described below.

The printing plate producing apparatus 110 according to the second embodiment of the present invention has an outer drum 20 for holding a “non-processing” PS plate P and an exposing/drawing head 130 which not only performs imagewise exposure on the PS plate P held on the outer drum 20 for a specified image to be recorded but which also performs ink jet drawing at specified positions on the PS plate P as the main characteristic feature of the second embodiment of the invention.

The printing plate producing apparatus 110 has the following additional components: a laser light source section 32 from which laser light modulated in accordance with the specified image to be recorded is transmitted to the exposing/drawing head 130, and an exposing/drawing control section 146 which controls the exposing and drawing actions of the laser light source section 32 and the exposing/drawing head 130.

Again, in the second embodiment under consideration, the direction in which the outer drum 20 rotates coincides with the main scanning direction for performing the exposing and ink jet drawing actions (as indicated by arrow A in FIG. 4).

The exposing/drawing head 130 is so adapted that it is capable of reciprocating over the already described guide mechanism 40 along the surface of the outer drum 20 in its axial direction. In the second embodiment under consideration, one of the directions in which the exposing/drawing head 130 reciprocates coincides with the auxiliary scanning direction (which is indicated by arrow B in FIG. 4).

The exposing/drawing head 130 consists an exposing head 36 and an ink jet print head 150. The exposing head 36 uses an image focusing optical system 34 to perform imagewise exposure on the PS plate P held on the surface of the outer drum 20 by applying the modulated laser light from the laser light source section 32; the ink jet print head 150 and the exposing head 36 are commonly placed on a moving base 130a, and the ink jet print head 150 performs drawing through ink-jet nozzles (and is hereunder referred to simply as the ink-jet head).

While the exposing head 36 used in the second embodiment need not be described in detail, the ink-jet head 150 may suitably be of a well-known type (see, for example, JP 10-230607 A) as in the case of the exposing head 36.

In the case under consideration, the width of printing (drawing) with the ink-jet head 150 may be adjusted to be equal to the width of swathing (exposing) with the exposing head 36 and the number of pixels to be exposed with the exposing head 36 may be adjusted to be an integral multiple of times the number of nozzles in the ink-jet head 150 (in other words, the number of nozzles in the ink-jet head 150 may be adjusted to be an integral multiple of times less than the number of pixels to be exposed with the exposing head 36); this is preferred because if the exposing head 36 and the ink-jet head 150 are moved an equal distance, they can effect exposing and drawing actions for the same distance, with the result that the drawing action of the ink-jet head 150 can keep pace with the exposing action of the exposing head 36, thus providing ease in controlling the positions of exposing and drawing with the exposing/drawing head 130. Take, for example, the case of using a 128-channel head as the exposing head 36 and exposing pixels at a density of 2400 dpi (which is equivalent to about 10.6 μm in pixel size); if the ink-jet head 150 is assumed to record dots at a density of 600 dpi (which is equivalent to about 42.3 μm in pixel size), the number of nozzles in the ink-jet head 150 may be adjusted to 32 channels as they are arranged at a density of 600 npi (which is equivalent to about 42.3 μm in nozzle spacing) and the number of dots to be recorded (or the density at which they are recorded) with the ink-jet head 150 may be adjusted to one-fourth the number of pixels to be exposed (or the density at which they are exposed) or, alternatively, the number of nozzles in the ink-jet head 150 may be adjusted to one-fourth the number of exposing channels.

The guide mechanism 40 for the exposing/drawing head 130 is for moving the exposing/drawing head 130 in the auxiliary scanning direction. In response to control signals (auxiliary scan timing signals) coming from the exposing/drawing control section 146 to be described later, the movement of the base 130a is controlled, which in turn controls the movement of the exposing/drawing head 130 in the auxiliary scanning direction.

The exposing head 36 exposes in a manner as described below: laser light coming from the laser light source section 32 after modulation on the basis of modulation signals in accordance with the image data from an exposure control sub-section 38 provided in the exposing/drawing control section 146 to be described later is transmitted through the image focusing optical system 34, whereupon it is focused on the PS plate P around the outer drum 20 to expose it.

The ink-jet head 150 is mounted on the moving base 130a which is also the base for the exposing head 36 and its operation is controlled by a drawing control sub-section 154 which is in the exposing/drawing control section 146 and which holds predetermined drawing positions and the associated drawing contents (i.e., the information that needs to be read in the printing step).

The exposing/drawing control section 146 under consideration has such a function that it causes the exposing head 36 and the ink-jet head 150 to be driven substantially at the same time. To be more specific, the exposing/drawing control section 146 controls the printing plate producing apparatus 110 in such a way that a single PS plate P is subjected to imagewise exposure by the exposing head 36 in predetermined positions while at the same time, drawing by the ink-jet head 150 is effected in positions which are also predetermined but different from the positions at which imagewise exposure is performed.

As described above, the exposing/drawing control section 146 not only functions to control the rotation of the outer drum 20 in the main scanning direction and the movement of the exposing/drawing head 130 (or the base 130a) in the auxiliary scanning direction as it carries the exposing head 36 and the ink-jet head 150, but it also functions to control the overall operations of the printing plate producing apparatus 110. In particular, for the purpose of recording an image on the PS plate P by means of the exposing head 36 and the ink-jet head 150, the exposing/drawing control section 146 has the functions of controlling various operations such as exposure and the drawing action of the ink-jet head 150.

FIG. 5 is an operational flow chart for the exposing/drawing control section 146 which shows the characteristic operations of the printing plate producing apparatus 110 according to the second embodiment for the purpose of illustrating how the above-mentioned operations are performed.

Remember that the exposing/drawing control section 146 in fact has the exposure control sub-section 38 which controls the exposing action of the exposing head 36 and the drawing control sub-section 154 which controls the drawing action of the ink-jet head 150.

In most cases, the aforementioned register marks and printing plate identifying information that are provided by the drawing action of the ink-jet head 150 are in the marginal portions of the PS plate P whereas the main image to be formed by the exposing action of the exposing head 36 occupies the non-marginal areas of the PS plate P. Hence, the exposing/drawing control section 146 is so adapted that the exposing control sub-section 38 and the drawing control sub-section 154 are moved in unison for scanning purposes (both main scanning and auxiliary scanning), whereby the action of providing the necessary information is accomplished efficiently.

Thus, as shown in FIG. 5, the exposing/drawing control section 146 comprises drawing subroutines that control the providing of a register mark 101 (see FIG. 4) and printing plate identifying information (typically a sequence of symbols) 102 (also see FIG. 4) by the drawing control sub-section 154 [and which consist of steps 70 and 72 (the first subroutine for drawing register marks) and steps 74 and 76 (the second subroutine for drawing the printing plate identifying information)] and the image forming third subroutine for controlling the formation of the main image by the exposing control sub-section 38 (and which consists of steps 78 and 80).

To state more specifically, when the exposing/drawing head 130 gets started from the reference position (so-called “home position”), the three subroutines 1-3 are actuated and stand by until the head reaches a preset drawing or exposing position, whereupon the relevant subroutine executes the necessary drawing or exposing action.

As regards the ink-jet head 150 on the exposing/drawing head 130, its monitoring is in process to see if it has reached the position where a register mark or printing plate identifying information should be drawn (step 70 or 74) and at the point in time when it has reached the respective intended position, a drawing action is executed (step 72 or 76). When a series of drawing actions have ended, the subroutine returns to the step of monitoring the head to see if it has reached the next drawing position.

In entirely the same manner, the exposing head 36 is being monitored to see if it has reached the position where the main image should be formed (step 78), and at the point in time when it has reached the intended position for starting exposure, an exposing action is started on the basis of preliminarily stored image data (step 80). This exposing process often covers a wider range and continues a longer time than the drawing action of the ink-jet head 150 but basically the two processes perform identical operational controls.

For drawing on the PS plate P, quick drying inks are preferably used rather than inks based on aqueous solvents. Depending on the need, uv curable inks can also be employed. Ink-jet heads that may suitably be used with those inks are exemplified by XJ500 printer head of SAAR and the compatible inks.

The exposing/drawing head 130 ends its operation at the point in time when the specified exposing and drawing actions have ended. This point in time may be determined by completion of the scanning of the areas over which the PS plate P on the outer drum 20 is exposed and subjected to drawing; it may be determined by other timings. All that is required is that an end command be supplied to the exposing/drawing control section 146 in response to such timings. When an end command is issued, actions for ending are taken (steps 82 and 84).

As already mentioned, the PS plate P on the outer drum 20 is in engagement with the latter by means of engaging means not shown. However, the distance between the ink-jet head 150 and the PS plate P on the outer drum 20 is only a few millimeters which is not different from the thickness of the engaging means; therefore, in order to ensure that it will not bump against the engaging means, the ink-jet head 150 is preferably provided with a moving means 152 for retracting it along the surface of the exposing/drawing head 130 (the direction in which the ink-jet head 150 is moved or retracted by the moving means 152 is indicated by arrow C in FIG. 4).

In the second embodiment described above, the exposing head 36 and the ink-jet head 150 which are mounted on the exposing/drawing head 130 are moved in synchronism and imagewise exposure for the main image by the exposing head 36 and the drawing of register marks and/or printing plate identifying information by the ink-jet head 150 can be performed efficiently, preferably at the same time, to form the necessary image on the PS plate P held around the outer drum 20.

In addition, despite the fact that the PS plate P is of a non-processing type (which is not supposed to receive wet development processing), the register marks or the printing plate identifying information that are obtained by the apparatus according to the embodiment under consideration can be set to have large enough differences in color or density; as a result, great visibility is obtained and due to such features as the ease in identifying various types of printing plates and in boring installation holes, significant contribution can be made to increase the operating efficiency of setting the printing plate on the press, thus helping a lot to make the non-processing printing plates very easy to use.

On the following pages, examples are provided to show how to make PS plates that can be suitably applied to the printing plate producing apparatus according to the second embodiment of the present invention, as well as to describe the results of making printing plates using the PS plates.

### EXAMPLES 3 AND 4

In Example 3, there was used the same PS plate as used in Example 1, and in Example 4, there was used the same PS plate as used in Example 2.

<Evaluating the Results of Printing Plate Production>

The image-carrying PS plates were not subjected to development processing but were immediately installed on the cylinder of SOR-M (printing press of Heidelberger Druckmaschinen AG). After supplying a fountain solution [EU-3 (liquid etchant of FUJI PHOTO FILM CO., LTD.)/water/isopropyl alcohol=1/89/10 (in volume ratio)] and black ink [TRANS-G (N) of DAINIPPON INK AND CHEMICALS, INCORPORATED), printing was done at a speed of 6,000 sheets per hour.

The number of printing sheets that were spent before the unexposed areas of the image recording layer had been removed from the printing press and the ink became no longer transferable to the printing sheets was counted as a measure of on-press developability. Whichever of the two PS plates described above was used, no more than 100 sheets were required before getting printed matter having no scum in the non-image area.

Printing was further continued and the impression capacity of the printing plates was evaluated in terms of runs that could be produced before the image area (the exposed areas of the image recording layer) had worn to cause reduced ink receptivity (i.e., the number of prints that could be obtained before the ink density (reflection density) had dropped by 0.1 from the initial value].

As it turned out, the results of producing printing plates according to the second embodiment of the present invention using the two PS plates of interest were very satisfactory. In addition, plate checking was performed before the PS plates were installed on the printing press and the operation was smooth in spite of the fact that they were of a non-processing type.

The two embodiments described above and the associated four examples are merely intended for illustrative purposes and it should be understood that the present invention is by no means limited to those embodiments and that various modifications and improvements can be made without departing from the spirit and scope of the invention.

What is claimed is:

1. A process for producing a printing plate without wet development processing, comprising the steps of:
exposing a printing plate so that an image is formed on said printing plate from an exposed area which has got a spectral absorption change to occur in an invisible range; as well as
reading said spectral absorption change in said invisible range that has occurred in said exposed area of said printing plate;
reconstructing as a visible image said image formed by the thus read spectral absorption change in said invisible range that occurred in said exposed area; and
outputting the thus reconstructed visible image.

2. The process for producing the printing plate according to claim 1, wherein said printing plate has an image forming layer which, upon irradiation with light having a wavelength in said invisible range, causes said spectral absorption change to occur in said invisible range and is exposed to said light having said wavelength in said invisible range.

3. The process for producing the printing plate according to claim 1, wherein said invisible range is an infrared range.

4. The process for producing the printing plate according to claim 1, wherein said exposing step of said printing plate is performed simultaneously with said reading step of said spectral absorption change in said exposed area of said printing plate, and said spectral absorption change in said exposed area that occurs immediately after exposure is read.

5. The process for producing the printing plate according to claim 1, wherein a first width of exposure in said exposing step of said printing plate is generally equal to a second width of reading from said printing plate in said reading step and a first number of pixels to be exposed in said exposing step of said printing plate is approximately an integral multiple of times a second number of pixels to be read from said printing plate in said reading step.

6. A process for producing a printing plate without wet development processing, comprising the steps of:
exposing a printing plate so that an image is formed on said printing plate from an exposed area which has got a spectral absorption change to occur in an invisible range; as well as
drawing information that needs to be read in a subsequent printing step on an area of said printing plate where said exposing step has ended with an ink jet.

7. The process for producing the printing plate according to claim 6, wherein said information contains at least register marks.

8. The process for producing the printing plate according to claim 6, wherein said printing plate has an image forming layer which, upon irradiation with light having a wavelength in said invisible range, causes said spectral absorption change to occur in said invisible range and is exposed to said light having said wavelength in said invisible range.

9. The process for producing the printing plate according to claim 6, wherein said invisible range is an infrared range.

10. The process for producing the printing plate according to claim 6, wherein said exposing step of said printing plate is performed simultaneously with said drawing step of said information by said ink jet, and said information is drawn with said ink jet in said area where said exposing step has just ended.

11. The process for producing the printing plate according to claim 6, wherein a first width of exposure in said exposing step of said printing plate is generally equal to a third width of drawing said information with said ink jet on said printing plate in said drawing step and a first number of pixels to be exposed in said exposing step of said printing plate is approximately an integral multiple of times a third number of pixels in said formation to be drawn with said ink jet on said printing plate in said drawing step.

12. An apparatus for producing a printing plate without wet development processing, comprising:
exposing means which exposes a printing plate to form an image on said printing plate from an exposed area which has got a spectral absorption change to occur in an invisible range;
reading means which reads said spectral absorption change in said invisible range that has occurred in said exposed area of said printing plate;
image reconstructing means which reconstructs as a visible image said image formed by the thus read spectral absorption change in said invisible range that occurred in said exposed area; and
output means for outputting the thus reconstructed visible image.

13. The apparatus for producing the printing plate according to claim 12, wherein said exposing means and said reading means move in synchronism.

14. The apparatus for producing the printing plate according to claim 12, wherein said reading means has a reading light source, image focusing optics and imaging means, said reading light source issuing light that has a wavelength in said invisible range and which does not cause said spectral absorption change to occur in said printing plate, said image focusing optics allowing said spectral absorption change in said exposed area of said printing plate to form a focused image on said imaging means, and said imaging means having sensitivity in said invisible range and detecting said spectral absorption change in said exposed area of said printing plate as image data.

15. The apparatus for producing the printing plate according to claim 12, wherein said printing plate has an image forming layer which, upon irradiation with light having a wavelength in said invisible range, causes said spectral absorption change to occur in said invisible range and is exposed to said light having said wavelength in said invisible range.

16. The apparatus for producing the printing plate according to claim 12, wherein a first width of exposure of said printing plate with said exposing means is generally equal to a second width of reading from said printing plate with said reading means and a first number of pixels to be exposed in the exposure of said printing plate with said exposing means is approximately an integral multiple of times a second number of pixels to be read from said printing plate with said reading means.

17. The apparatus for producing the printing plate according to claim 12, wherein said invisible range is an infrared range.

18. An apparatus for producing a printing plate without wet development processing, comprising:
exposing means which exposes a printing plate to form an image on said printing plate from an exposed area which has got a spectral absorption change to occur in an invisible range; and
ink-jet drawing means for drawing information that needs to be read in a subsequent printing step on an area of said printing plate where said exposing step has ended with an ink jet.

19. The apparatus for producing the printing plate according to claim 18, wherein said information contains at least register marks.

20. The apparatus for producing the printing plate according to claim 18, wherein said exposing means and said ink-jet drawing means move in synchronism.

21. The apparatus for producing the printing plate according to claim 18, wherein said printing plate has an image forming layer which, upon irradiation with light having a wavelength in said invisible range, causes said spectral absorption change to occur in said invisible range and is exposed to said light having said wavelength in said invisible range.

22. The apparatus for producing the printing plate according to claim 18, wherein said invisible range is an infrared range.

23. The apparatus for producing the printing plate according to claim 18, wherein said ink-jet drawing means has a plurality of ink-jet nozzles, and said exposing means adopts a multi-beam exposing system.

24. The apparatus for producing the printing plate according to claim 23, wherein a first width of exposure in said exposing step of said printing plate is generally equal to a third width of drawing said information on said printing plate with said ink-jet drawing means and a first number of pixels to be exposed in said exposure of said printing plate with said exposing means is approximately an integral multiple of times a third number of ink-jet nozzles in said ink-jet drawing means.
